(19) United States
(12) Patent Application Publication
(10) Pub. No.: US 2007/0096686 A1
(43) Pub. Date: May 3, 2007

(54) Implantable device with heat absorption material

(75) Inventors: Oscar Jimenez, Coral Gables, FL (US); Guillermo Echarri, Miami, FL (US); Roberto Echarri, Miami, FL (US)

Correspondence Address: FOLEY & LARDNER LLP, 777 EAST WISCONSIN AVENUE, MILWAUKEE, WI, 53202-5306, US

(73) Assignee: Medtronic, Inc.

(21) Appl. No.: 11/429,659

(22) Filed: May 5, 2006

Related U.S. Application Data
(60) Provisional application No. 60/678,501, filed on May 6, 2005.

(51) Int. Cl. H02J 7/00

(52) U.S. Cl. 320/108

(57) ABSTRACT

A system for charging a battery associated with an implantable medical device includes an inductive charging mechanism that includes a primary coil and a secondary coil. The primary coil is configured to be provided external to a human body and the secondary coil is configured to be provided within the human body proximate the primary coil. A material at least partially encapsulates the primary coil for absorbing heat generated by the primary coil.

### CROSS-REFERENCE TO RELATED APPLICATIONS

The present application claims the benefit of U.S. Provisional Patent Application No. 60/678,501, filed May 6, 2005, the entire disclosure of which is incorporated by reference herein.

### BACKGROUND

The present invention relates generally to the field of implantable medical devices. More specifically, the present invention relates to implantable medical devices that may be charged inductively through the skin of an individual in which they are implanted.

Implantable medical devices (IMDs) such as pacemakers and the like may include a battery that requires periodic recharging. Such IMDs may utilize an inductive charging system in which a primary coil is provided adjacent the outer surface of the skin and a secondary coil is provided inside the body beneath the subcutaneous skin layer. The separation of the primary and secondary coils is generally determined at least in part by the thickness of the subcutaneous layer beneath the skin (which is necessary for a stable implant and for preventing tissue erosion). A voltage is induced in the secondary coil by providing a current though the primary coil, and the voltage in the secondary coil is used to charge the battery.

One issue associated with conventional inductive charging systems is that the use of such systems may cause an increase in temperature in the adjacent skin tissue of a patient. Such temperature increases may result from, for example, heat flux from the primary coil, heat flux from the metal enclosure used for the IMD, and/or heat generated within the tissue due to eddy currents.

It would be advantageous to provide a system that reduces the amount of heat generated in the tissues between the primary and secondary coils for an inductive charging device for an implantable medical device. It would also be desirable to provide a system for reducing the amount of heat generated without relatively expensive or complicated re-designs of existing structures (e.g., coils, etc.). It would be desirable to provide a system that provides any one or more of these or other advantageous features as will be appreciated by those of skill in the art reviewing this disclosure.

### SUMMARY

An exemplary embodiment of the invention relates to a system for charging a battery associated with an implantable medical device. The system includes an inductive charging mechanism that includes a primary coil and a secondary coil. The primary coil is configured to be provided external to a human body and the secondary coil is configured to be provided within the human body proximate the primary coil. A material at least partially encapsulates the primary coil for absorbing heat generated by the primary coil and acts to reduce the amount of heat transferred from the primary coil to the human body.

Another exemplary embodiment of the invention relates to an inductive charging system for an implantable medical device. The inductive charging system includes a primary coil provided adjacent an external surface of a human body and a secondary coil provided within the human body and inductively coupled to the primary coil. The inductive charging system also includes a heat absorption material provided in contact with the primary coil for drawing heat from the primary coil. According to an exemplary embodiment, the heat absorption material includes a wax.

Another exemplary embodiment of the invention relates to a system for providing a therapeutic treatment to a patient. The system includes a medical device provided within a human body and including a battery for providing power to the medical device. The system also includes a system coupled to the battery for charging the battery that includes a first component provided adjacent an external surface of a human body and a second component provided within the human body proximate the first component. The first component is inductively coupled to the second component. A material at least partially surrounds the first component and is configured to absorb heat from the first component.

### BRIEF DESCRIPTION OF THE DRAWINGS

FIG. 1 is a schematic view of an inductive charging system according to an exemplary embodiment.

FIG. 2 is a schematic view of a portion of the inductive charging system shown in FIG. 1 illustrating the behavior of a material provided adjacent a primary coil of an inductive charging system during charging.

FIG. 3 is a schematic view of an implantable medical device (IMD) provided within the body of a patient.

FIG. 4 is a schematic view of another implantable medical device (IMD) provided within the body of a patient.

### DETAILED DESCRIPTION OF EXEMPLARY EMBODIMENTS

Inductive charging systems (e.g., transcutaneous energy transfer or TET devices) may be used to charge one or more rechargeable batteries (e.g., nickel metal hydride batteries, lithium-ion batteries, lithium-polymer batteries, etc.) utilized to provide power for an implantable medical device. Such inductive charging systems conventionally include a primary or external coil located adjacent an external surface of the skin and a secondary or internal coil located proximate the primary coil and underneath a subcutaneous layer in the skin. The separation of the primary and secondary coils is generally determined at least in part by the thickness of the subcutaneous layer, which is necessary to provide a stable implant and for preventing tissue erosion.

The choice of frequency applied to the primary coil during battery charging operations is a compromise between a number of factors. For example, it is known that the higher the frequency applied to the primary coil, the greater will be the induced voltage in the secondary coil. Various losses may also result, including attenuation losses in tissues separating the coils and eddy current losses, both of which increase with frequency. The physical design of the primary coil may also be taken into account, which is a compromise between physical size, wire gauge, and the D.C. resistance of the coil.

It has been discovered and verified experimentally by the inventors that temperature increases in the tissues adjacent the primary coil may be attributed primarily to the heat flux from the primary coil (due to the i²R in the coil, which is the rms value for the charging current) into the body. Other factors which may be partially responsible for the temperature increases include the heat flux from the metal enclosure (eddy currents) and the heat generated within the tissues due to eddy currents.

To ensure comfort to the patient, it may be desirable to prevent a temperature increase at the skin during charging of more than approximately 2° C., although different individuals may have different tolerances in this regard.

To reduce the amount of heat transferred from the primary coil to the adjacent body tissue, one potential solution is to modify the physical structure of the coil (e.g., by using a larger gauge wire, by using a better conductor such as silver (as opposed to copper), and/or by increasing the radius of the coil). Such solutions may be unacceptable for various reasons, including space constraints within the various components and increased expense. For example, if the radius of the primary coil is increased, a corresponding modification to the secondary coil must also be made, which may unacceptably increase the size of the implanted structure.

Other potential solutions involve the use of cooling and/or heat transfer using a fan, heat exchanger, or other device for circulating air or fluid across the primary coil. Such solutions may be relatively costly, inefficient, complicated, and potentially unreliable in practice.

Another potential solution is to charge the battery at a lower charging rate to take advantage of the natural heat dissipation provided by the human body (e.g., due to circulation in the tissue). However, the use of such lower charging rates may result in an unacceptable increase in the required battery charging time. To provide an enhanced patient experience, it is desirable to charge the battery in a relatively quick and efficient manner in order to minimize any inconvenience to the patient. Accordingly, the inventors have created a system in which a relatively rapid charging rate may be utilized without a significant corresponding temperature increase in the body tissues adjacent the charging mechanism.

According to an exemplary embodiment of the present invention, a material for absorbing heat (e.g., a heat sink) is provided that at least partially surrounds or encapsulates the primary coil. Such a material advantageously acts to shunt heat away from the body tissues to minimize the absorption of heat by such body tissues.

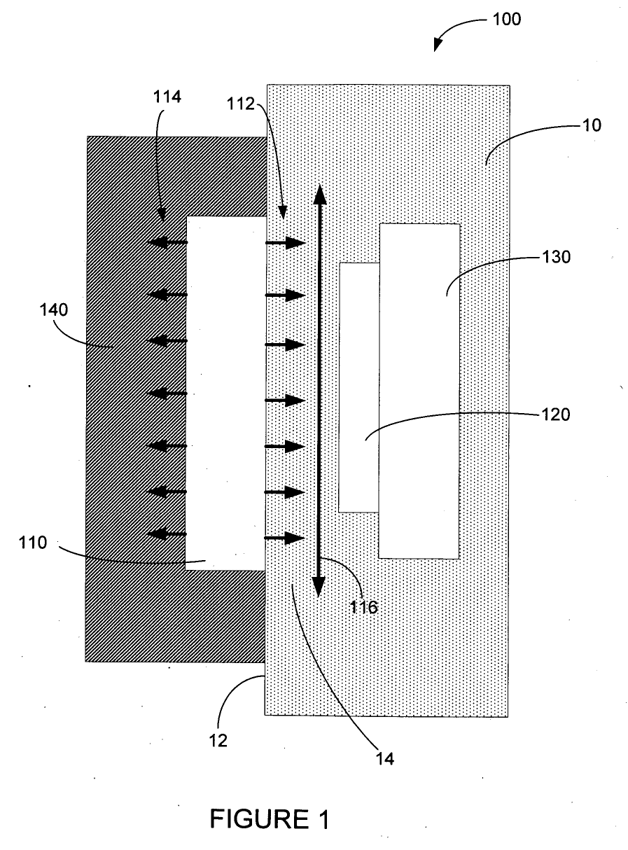

FIG. 1 is a schematic view of an inductive charging system 100 according to an exemplary embodiment. A primary or external coil 110 is provided adjacent an outer surface 12 of the skin of a human body 10. According to an exemplary embodiment, the primary coil 110 is made of copper.

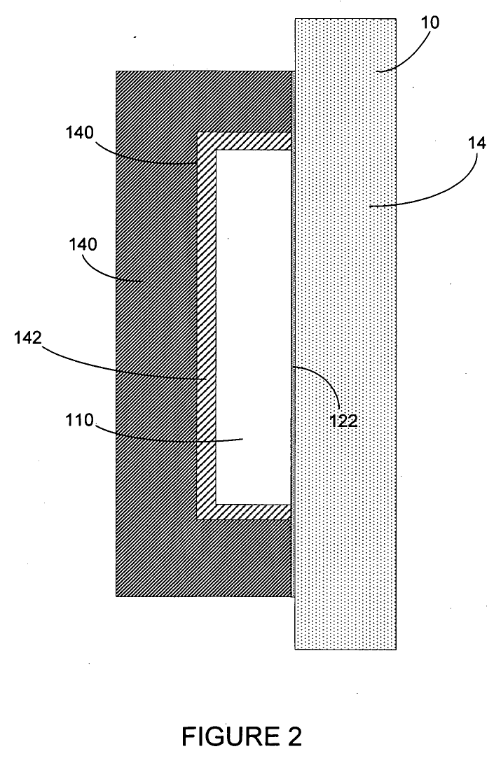

As shown in FIG. 2, a thermal barrier 122 such as a polymeric film may be provided intermediate the primary coil 110 and the surface 12 of the skin according to an exemplary embodiment.

A secondary or internal coil 120 is provided within the body 10 below a subcutaneous skin layer 14. Current traveling through the primary coil 110 acts to induce a voltage in the secondary coil 120. The secondary coil 120 is electrically coupled to at least a portion of an implantable medical device 130 that includes a rechargeable battery (e.g., a nickel metal hydride battery, a lithium-ion battery, a lithium-polymer battery, etc.). While the implantable medical device 130 is shown as being provided adjacent and in contact with the secondary coil 120, all or a portion of the implantable medical device 130 may be provided elsewhere within the body 10 according to other exemplary embodiments.

As shown in FIG. 1, a material 140 is provided in contact with the primary coil 110 and a portion of the skin 12 such that the material 140 at least partially surrounds or encapsulates the primary coil 110. According to an exemplary embodiment, the material 140 is intended to act as a heat sink that draws heat away from the primary coil 110 before it can travel to the tissue adjacent the primary coil. The material 140 may be provided such that it is contained within a non-conductive container such as a polymer bag (not shown).

During charging operations in which current is generated in the primary coil 110, heat is given off by the primary coil. Arrows 112 shown in FIG. 1 represent the heat flux from the primary coil into the body 10 and arrows 114 represent the heat flux from the primary coil into the material 140. Arrow 116 is representative of the cooling effect due to circulation in the body 10 beneath the surface 12 of the skin. It should be noted that the thermal barrier 122 (as shown in FIG. 2) also acts to minimize the amount of heat transferred from the primary coil 110 into the body 10.

FIG. 2 is a schematic drawing illustrating the conduction of heat from the primary coil 110 into the material 140 during a charging operation. A portion of the material 140 begins to melt as the temperature of the primary coil 110 increases, forming a molten or liquid region or portion 142 adjacent a solid portion or region 144. The overall temperature of the material 140 does not increase significantly during this operation, however, since the heat is transferred through the relatively large surface area interface 143 between the solid and molten material into the solid portion 144. The temperature of the material 140 is approximately equal to that of the body 10 and is less than that of the primary coil 110 during the charging operation, while the temperatures of the secondary coil 120, the implant 130, and the body 10 are approximately equal.

The material 140 is chosen such that it is a relatively efficient heat absorber (e.g., it exhibits a relatively low temperature rise per unit of heat), remains at a temperature near 40° C. (e.g., between approximately 32° C. and 48° C., and more particularly between approximately 36° C. and 41° C.) as it absorbs heat, and is relatively easy to mold such that it can be conformed to the human body and around the primary coil 110. It is also desirable that the material 140 be relatively electrically non-conductive to prevent additional eddy-current losses, non-toxic to the human body, and a moderately good heat conductor to allow it to carry heat away from the external coil to prevent hot spots from forming.

According to an exemplary embodiment, the material 140 is a natural wax or a paraffin wax having a melting point that is near the temperature of a human body (e.g., approximately 37° C.). For example, according to various exemplary embodiments, the material 140 includes one or more natural waxes such as wool wax (melting point between approximately 36° C. and 43° C.), orange peel (melting point between approximately 44° C. and 46.5° C.), cape berry (Myrica cardifolia) (melting point between approximately 40.5° C. and 45° C.), or bayberry (melting point between approximately 46.7° C. and 48° C.).

According to other exemplary embodiments, the material 140 includes one or more paraffin waxes such as saturated alkanes having between 19 and 23 carbon atoms. For example, the material 140 may include nonadecane (C₁₉H₄₀), eicosane (C₂₀H₄₂), heneicosane (C₂₁H₄₄), docosane (C₂₂H₄₆), or tricosane (C₂₃H₄₈). According to one particular exemplary embodiment, the material 140 is eicosane (C₂₀H₄₂). According to another particular exemplary embodiment, the material 140 is heneicosane (C₂₁H₄₄). The approximate melting points of various saturated alkanes are shown in Table 1.

TABLE 1

| | | Approximate Melting |
|---|---|---|
| Name | Formula | Point (° C.) |
| nonadecane | C₁₉H₄₀ | 32.0 |
| eicosane | C₂₀H₄₂ | 36.4 |
| heneicosane | C₂₁H₄₄ | 40.4 |
| docosane | C₂₂H₄₆ | 44.4 |
| tricosane | C₂₃H₄₈ | 47.4 |

It should be noted that the material 140 may include more than one natural or paraffin wax (or combinations thereof) according to various exemplary embodiments. For example, the material 140 may include both eicosane and heneicosane according to an exemplary embodiment. Various other combinations of natural and paraffin waxes may be used for the material 140 as those of skill in the art will appreciate upon reviewing this disclosure. Other classes of organic materials (e.g., fatty acids and esters (carboxylic acids) such as capric acid (decanoic acid) having a melting point of 31.2° C). and inorganic materials (e.g., salt hydrates, sodium hydrogen phosphate having a melting point of 36.1° C.) may also be used.

According to an exemplary embodiment, the material 140 is configured to maintain the temperature of the primary coil and the nearby tissues of the body at a temperature of between approximately 36° C. and 40° C. for a period of five hours during a charging operation. According to a particular exemplary embodiment, the material 140 acts to prevent a rise in temperature in the nearby tissues more than 2° C. for such a charging period.

The amount of the material 140 provided may be selected to absorb a desired amount of heat that corresponds to the amount of heat evolved from the primary coil 110 during a standard charging operation. For example, according to one exemplary embodiment, it is estimated that approximately 36 kilojoules (kJ) of heat may be evolved from the primary coil during a charging period of approximately five hours. According to an exemplary embodiment, the volume of the material 140 used to partially surround or encapsulate the primary coil 110 is approximately 300 cm³. According to other exemplary embodiments, the volume of the material 140 may differ based on any number of parameters, including the size and composition of the primary coil, the amount of heat generated by the primary coil, the composition of the material 140, and/or any of a variety of other factors.

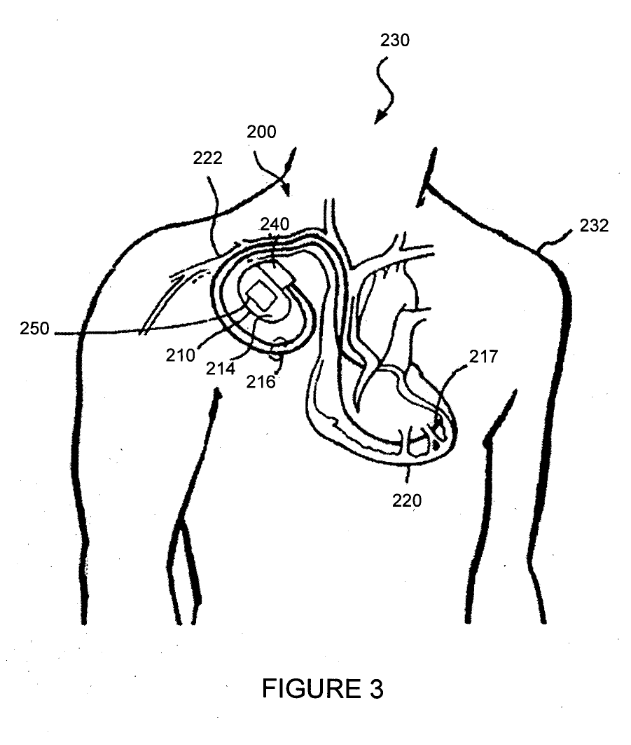

FIG. 3 illustrates a schematic view of a system 200 (e.g., an implantable medical device) implanted within a body or torso 232 of a patient 230. The system 200 includes a device 210 in the form of an implantable medical device that for purposes of illustration is shown as a defibrillator configured to provide a therapeutic high voltage (e.g., 700 volt) treatment for the patient 230.

The device 210 includes a container or housing 214 that is hermetically sealed and biologically inert according to an exemplary embodiment. The container may be made of a conductive material. One or more leads 216 electrically connect the device 210 and to the patient's heart 220 via a vein 222. Electrodes 217 are provided to sense cardiac activity and/or provide an electrical potential to the heart 220. At least a portion of the leads 216 (e.g., an end portion of the leads shown as exposed electrodes 217) may be provided adjacent or in contact with one or more of a ventricle and an atrium of the heart 220.

The device 210 includes a battery 240 provided therein to provide power for the device 210. The size and capacity of the battery 240 may be chosen based on a number of factors, including the amount of charge required for a given patient's physical or medical characteristics, the size or configuration of the device, and any of a variety of other factors. According to an exemplary embodiment, the battery is a 5 mAh battery. According to another exemplary embodiment, the battery is a 300 mAh battery. According to various other exemplary embodiments, the battery may have a capacity of between approximately 10 and 1000 mAh.

According to other exemplary embodiments, more than one battery may be provided to power the device 210. In such exemplary embodiments, the batteries may have the same capacity or one or more of the batteries may have a higher or lower capacity than the other battery or batteries. For example, according to an exemplary embodiment, one of the batteries may have a capacity of approximately 500 mAh while another of the batteries may have a capacity of approximately 75 mAh.

According to an exemplary embodiment, the battery may be configured such that it may be charged and recharged using an inductive charging system (shown, for example, in FIG. 1) in which a primary or external coil is provided at an exterior surface of a portion of the body (either proximate or some distance away from the battery) and a secondary or internal coil is provided below the skin adjacent the primary coil.

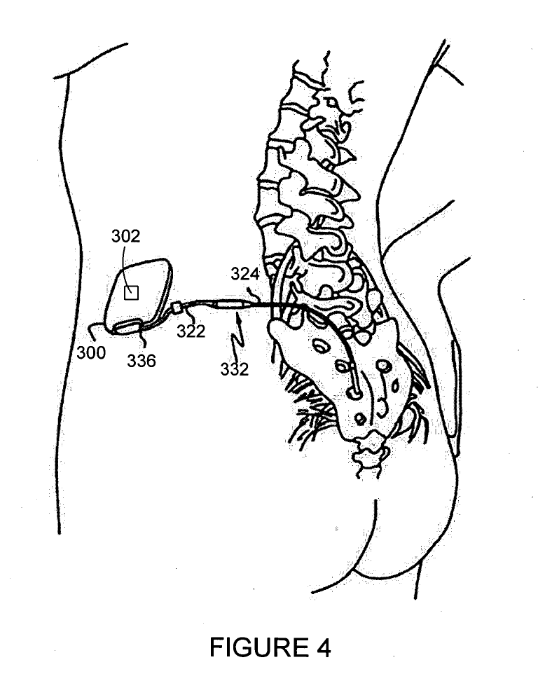

According to another exemplary embodiment shown in FIG. 4, an implantable neurological stimulation device 300 (an implantable neuro stimulator or INS) may include a battery 302 such as those described above with respect to the various exemplary embodiments. Examples of some neuro stimulation products and related components are shown and described in a brochure titled “Implantable Neurostimulation Systems” available from Medtronic, Inc.

An INS generates one or more electrical stimulation signals that are used to influence the human nervous system or organs. Electrical contacts carried on the distal end of a lead are placed at the desired stimulation site such as the spine or brain and the proximal end of the lead is connected to the INS. The INS is then surgically implanted into an individual such as into a subcutaneous pocket in the abdomen, pectoral region, or upper buttocks area. A clinician programs the INS with a therapy using a programmer. The therapy configures parameters of the stimulation signal for the specific patient's therapy. An INS can be used to treat conditions such as pain, incontinence, movement disorders such as epilepsy and Parkinson's disease, and sleep apnea. Additional therapies appear promising to treat a variety of physiological, psychological, and emotional conditions. Before an INS is implanted to deliver a therapy, an external screener that replicates some or all of the INS functions is typically connected to the patient to evaluate the efficacy of the proposed therapy.

The INS 300 includes a lead extension 322 and a stimulation lead 324. The stimulation lead 324 is one or more insulated electrical conductors with a connector 332 on the proximal end and electrical contacts (not shown) on the distal end. Some stimulation leads are designed to be inserted into a patient percutaneously, such as the Model 3487A Pisces-Quad® lead available from Medtronic, Inc. of Minneapolis Minn., and stimulation some leads are designed to be surgically implanted, such as the Model 3998 Specify® lead also available from Medtronic.

Although the lead connector 332 can be connected directly to the INS 500 (e.g., at a point 336), typically the lead connector 332 is connected to a lead extension 322. The lead extension 322, such as a Model 7495 available from Medtronic, is then connected to the INS 300.

Implantation of an INS 320 typically begins with implantation of at least one stimulation lead 324, usually while the patient is under a local anesthetic. The stimulation lead 324 can either be percutaneously or surgically implanted. Once the stimulation lead 324 has been implanted and positioned, the stimulation lead's 324 distal end is typically anchored into position to minimize movement of the stimulation lead 324 after implantation. The stimulation lead's 324 proximal end can be configured to connect to a lead extension 322.

The INS 300 is programmed with a therapy and the therapy is often modified to optimize the therapy for the patient (i.e., the INS may be programmed with a plurality of programs or therapies such that an appropriate therapy may be administered in a given situation).

A physician programmer and a patient programmer (not shown) may also be provided to allow a physician or a patient to control the administration of various therapies. A physician programmer, also known as a console programmer, uses telemetry to communicate with the implanted INS 300, so a clinician can program and manage a patient's therapy stored in the INS 300, troubleshoot the patient's INS 300 system, and/or collect data. An example of a physician programmer is a Model 7432 Console Programmer available from Medtronic. A patient programmer also uses telemetry to communicate with the INS 300, so the patient can manage some aspects of her therapy as defined by the clinician. An example of a patient programmer is a Model 7434 Itrel® 3 EZ Patient Programmer available from Medtronic.

According to an exemplary embodiment, a battery provided as part of the INS 300 may be configured such that it may be charged and recharged using an inductive charging system (shown, for example, in FIG. 1) in which a primary or external coil is provided at an exterior surface of a portion of the body (either proximate or some distance away from the battery) and a secondary or internal coil is provided below the skin adjacent the primary coil.

While the medical devices described herein (e.g., systems 200 and 300) are shown and described as a defibrillator and a neurological stimulation device, it should be appreciated that other types of implantable medical devices may be utilized according to other exemplary embodiments, such as pacemakers, cardioverters, cardiac contractility modules, drug administering devices, diagnostic recorders, cochlear implants, and the like for alleviating the adverse effects of various health ailments.

It is also contemplated that the medical devices described herein may be charged or recharged when the medical device is implanted within a patient. That is, according to an exemplary embodiment, there is no need to disconnect or remove the medical device from the patient in order to charge or recharge the medical device.

It is important to note that the construction and arrangement of the implantable device and other structures as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the preferred and other exemplary embodiments without departing from the scope of the present inventions as expressed in the appended claims.

What is claimed is:

1. A system for charging a battery associated with an implantable medical device comprising:
an inductive charging mechanism comprising a primary coil and a secondary coil, the primary coil configured to be provided external to a human body and the secondary coil configured to be provided within the human body proximate the primary coil; and
a material at least partially encapsulating the primary coil for absorbing heat generated by the primary coil;
whereby the material acts to reduce the amount of heat transferred from the primary coil to the human body.

2. The system of claim 1, wherein the material comprises a natural wax.

3. The system of claim 2, wherein the natural wax comprises at least one material selected from the group consisting of wool wax, orange peel, cape berry, and bayberry.

4. The system of claim 1, wherein the material comprises a paraffin wax.

5. The system of claim 1, wherein the material comprises a saturated alkane having between 19 and 23 carbon atoms.

6. The system of claim 1, wherein the material comprises at least one material selected from the group consisting of eicosane (C₂₀H₄₂) and heneicosane (C₂₁H₄₄).

7. The system of claim 1, wherein the material has a melting point of between approximately 32° C. and 48° C.

8. The system of claim 1, wherein the material has a melting point of between approximately 36° C. and 41° C.

9. The system of claim 1, wherein the material has a melting point approximately equal to the temperature of the human body.

10. The system of claim 1, wherein the material has a volume of approximately 300 cm³.

11. The system of claim 1, further comprising a thermal barrier provided between the primary coil and a surface of the human body.

12. The system of claim 11, wherein the thermal barrier comprises a polymeric film.

13. The system of claim 1, wherein the secondary coil is electrically coupled to an implantable medical device.

14. The system of claim 13, wherein the implantable medical device is selected from the group consisting of a cardiac defibrillator, a cardiac pacemaker, a cardiac contractility module, a cardiac contractility modulator, a cardioverter, a drug administration device, a cochlear implant, a hearing aid, a sensor, a telemetry device, and a diagnostic recorder.

15. An inductive charging system for an implantable medical device comprising:
a primary coil provided adjacent an external surface of a human body;
a secondary coil provided within the human body and inductively coupled to the primary coil; and
a heat absorption material provided in contact with the primary coil for drawing heat from the primary coil;
wherein the heat absorption material comprises a wax.

16. The inductive charging system of claim 15, wherein the heat absorption material comprises a wax comprising at least one material having a melting point that is between approximately 32° C. and 48° C.

17. The inductive charging system of claim 15, wherein the heat absorption material comprises a natural wax selected from the group consisting of wool wax, orange peel, cape berry, and bayberry.

18. The inductive charging system of claim 15, wherein the heat absorption material comprises a paraffin wax.

19. The inductive charging system of claim 15, wherein the heat absorption material comprises an alkane having between 19 and 23 carbon atoms.

20. The inductive charging system of claim 15, wherein the heat absorption material comprises at least one material selected from the group consisting of eicosane (C₂₀H₄₂) and heneicosane (C₂₁H₄₄).

21. The inductive charging system of claim 15, wherein the material has a melting point of between approximately 32° C. and 48° C.

22. The inductive charging system of claim 15, wherein the material has a melting point of between approximately 36° C. and 41° C.

23. The inductive charging system of claim 15, wherein the secondary coil is electrically coupled to a battery of an implanted medical device for charging the battery.

24. The inductive charging system of claim 23, wherein the implanted medical device is selected from the group consisting of a cardiac defibrillator, a cardiac pacemaker, a cardiac contractility module, a cardiac contractility modulator, a cardioverter, a drug administration device, a cochlear implant, a hearing aid, a sensor, a telemetry device, and a diagnostic recorder.

25. A system for providing a therapeutic treatment to a patient comprising:
a medical device provided within a human body and comprising a battery for providing power to the medical device;
a system coupled to the battery for charging the battery comprising:
a first component provided adjacent an external surface of a human body; and
a second component provided within the human body proximate the first component, the first component inductively coupled to the second component; and
a material at least partially surrounding the first component and configured to absorb heat from the first component.

26. The system of claim 25, wherein the heat absorption material comprises a natural wax.

27. The system of claim 26, wherein the natural wax includes at least one material selected from the group consisting of wool wax, orange peel, cape berry, and bayberry.

28. The system of claim 25, wherein the material comprises a paraffin wax.

29. The system of claim 25, wherein the material comprises a saturated alkane having between 19 and 23 carbon atoms in its carbon backbone.

30. The system of claim 25, wherein the material comprises at least one material selected from the group consisting of eicosane (C₂₀H₄₂) and heneicosane (C₂₁H₄₄).

31. The system of claim 25, wherein the material has a melting point of between approximately 36° C. and 41° C.

32. The system of claim 25, wherein the second component is coupled to a battery of an implanted medical device for charging the battery.

33. The inductive charging system of claim 32, wherein the implanted medical device is selected from the group consisting of a cardiac defibrillator, a cardiac pacemaker, a cardiac contractility module, a cardiac contractility modulator, a cardioverter, a drug administration device, a cochlear implant, a hearing aid, a sensor, a telemetry device, and a diagnostic recorder.
